(19) United States
(12) Patent Application Publication
(10) Pub. No.: US 2026/0093607 A1
(43) Pub. Date: Apr. 2, 2026

(54) METHOD AND SYSTEM FOR TESTING SOFTWARE ARTEFACTS FOR REUSE VIA SEMANTIC SEARCH

(71) Applicant: JPMorgan Chase Bank, N.A., New York, NY (US)

(72) Inventors: Robert WHITE, London (GB); Vali TAWOSI, London (GB); Salwa Husam ALAMIR, Bournemouth (GB); Xiaomo LIU, Manhasset, NY (US); Tim STODDART, Surrey (GB); Surekha C. GRACIAS, Livingston, NJ (US); Sameena SHAH, Scarsdale, NY (US)

(73) Assignee: JPMorgan Chase Bank, N.A., New York, NY (US)

(21) Appl. No.: 18/903,810

(22) Filed: Oct. 1, 2024

(51) Int. Cl. G06F 11/36; G06F 8/36

(52) U.S. Cl. CPC G06F 11/3672; G06F 8/36; G06F 11/3696

(57) ABSTRACT

Various methods and processes, apparatuses or systems, and media for using a semantic search approach for identifying and recommending testing software artefacts for reuse for testing new software functionality are disclosed. The method includes: receiving stories that include natural language textual descriptions of sets of user requirements; converting, by using a predetermined text vectorization technique, each story into a respective embedding that includes a respective vector representation thereof; receiving a new story, and converting the new story into a new embedding; comparing the new embedding to each respective embedding, and generating a respective similarity score that relates to a respective semantic similarity between the respective embedding and the new embedding; for each respective embedding having a high similarity score, identifying testing artefact(s) that are associated with the respective story; and generating a list of recommendations based on the identified testing artefact(s).

### TECHNICAL FIELD

This disclosure relates to methods and apparatuses for using a semantic search approach for identifying and recommending testing software artefacts for reuse for testing new software functionality.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

The reuse of software artefacts is a powerful tool that has the power to reduce the effort spent and time taken to develop software while improving the output by reusing mature, well-tested code. Testing is one area of software development that can benefit greatly from reuse, as many software tests are very similar to each other, and it is often true that similar functionality is tested by similar tests. In this aspect, an identification and recommendation of suitable software artefacts for reuse may reduce unnecessary usage of system resources, such as memory capacity and system throughput, which may otherwise be required by the software development and testing process. In addition, the identification and recommendation of suitable software artefacts for reuse may also improve computer functionality by advantageously leveraging the fact that the reusable code has previously been tested and successfully deployed.

Accordingly, there is a need for a mechanism for using a semantic search approach for identifying and recommending testing software artefacts for reuse for testing new software functionality.

### SUMMARY

The present disclosure, through one or more of its various aspects, embodiments, and/or specific features or sub-components, provides, among other features, various systems, servers, devices, methods, media, programs, and platforms for automatically assigning metadata values, such as access class values and sensitivity values, to data elements within a data lake catalog in an accurate and efficient manner.

According to an aspect of the present disclosure, a method for identifying and recommending software artefacts for reuse for testing new software functionality is provided. The method may be implemented by at least one processor. The method includes: receiving a first set of stories, each respective story included in the first set of stories including a natural language textual description of a respective set of user requirements; converting, by using a predetermined text vectorization technique, each respective story into a respective embedding that includes a respective vector representation of the respective story; storing each respective embedding in a vector database; receiving, from a first user, a new story that includes a natural language textual description of a first set of requirements that correspond to the first user; converting, by using the predetermined text vectorization technique, the new story into a new embedding; comparing the new embedding to each respective embedding stored in the vector database; generating, based on a result of the comparing for each respective embedding, a respective similarity score that relates to a respective semantic similarity between the respective embedding and the new embedding; rank-ordering each respective embedding based on the respective similarity score; for a respective embedding having at least a predetermined first rank, identifying at least one respective testing artefact that is associated with the respective story; generating a list of recommendations based on the identified at least one testing artefact; and displaying the list via a display that is accessible by the first user.

The at least one respective testing artefact may include at least one from among a manual test plan that is associated with the respective story and an automated test script that is associated with the respective story.

The method may further include displaying, for each respective identified testing artefact, a respective set of buttons that are configured to facilitate interaction with the first user, the respective set of buttons including a first button that corresponds to downloading the respective identified testing artefact, a second button that corresponds to providing first feedback that indicates that the respective identified testing artefact is fully useful, a third button that corresponds to providing second feedback that indicates that the respective identified testing artefact is partly useful, and a fourth button that corresponds to providing third feedback that indicates that the respective identified testing artefact is not useful.

The converting of each respective story into the respective embedding may include: using at least one data ablation study to determine at least one portion of the respective story that has significant relevance; and generating the respective embedding based on the at least one portion of the respective story that is determined as having the significant relevance.

The at least one portion of the respective story that is determined as having the significant relevance may include each of a summary of the respective story and a description of the respective story.

The converting of each respective story into the respective embedding and the converting of the new story into the new embedding may be performed by using an E5 embedding model.

The comparing and the generating of the respective similarity score may be performed by using a first artificial intelligence / machine learning (AI/ML) model that is trained by using historical testing artefact data.

The comparing may include applying a predetermined cosine similarity algorithm to each respective embedding with respect to the new embedding.

The identifying of the at least one respective testing artefact that is associated with the respective story may include identifying at least a predetermined number of respective testing artefacts. The predetermined number of respective testing artefacts may be greater than or equal to five (5).

According to another embodiment, a computing apparatus for identifying and recommending software artefacts for reuse for testing new software functionality is provided. The computing apparatus includes a processor; a memory; and a communication interface coupled to each of the processor and the memory. The processor may be configured to: receive, via the communication interface, a first set of stories, each respective story included in the first set of stories including a natural language textual description of a respective set of user requirements; convert, by using a predetermined text vectorization technique, each respective story into a respective embedding that includes a respective vector representation of the respective story; store each respective embedding in a vector database within the memory; receive, from a first user via the communication interface, a new story that includes a natural language textual description of a first set of requirements that correspond to the first user; convert, by using the predetermined text vectorization technique, the new story into a new embedding; compare the new embedding to each respective embedding stored in the vector database; generate, based on a result of the comparison for each respective embedding, a respective similarity score that relates to a respective semantic similarity between the respective embedding and the new embedding; rank-order each respective embedding based on the respective similarity score; for a respective embedding having at least a predetermined first rank, identify at least one respective testing artefact that is associated with the respective story; generate a list of recommendations based on the identified at least one testing artefact; and display the list via a display that is accessible by the first user.

The at least one respective testing artefact may include at least one from among a manual test plan that is associated with the respective story and an automated test script that is associated with the respective story.

The processor may be further configured to display, for each respective identified testing artefact, a respective set of buttons that are configured to facilitate interaction with the first user, the respective set of buttons including a first button that corresponds to downloading the respective identified testing artefact, a second button that corresponds to providing first feedback that indicates that the respective identified testing artefact is fully useful, a third button that corresponds to providing second feedback that indicates that the respective identified testing artefact is partly useful, and a fourth button that corresponds to providing third feedback that indicates that the respective identified testing artefact is not useful.

The processor may be further configured to perform the conversion of each respective story into the respective embedding by: using at least one data ablation study to determine at least one portion of the respective story that has significant relevance; and generating the respective embedding based on the at least one portion of the respective story that is determined as having the significant relevance.

The at least one portion of the respective story that is determined as having the significant relevance may include each of a summary of the respective story and a description of the respective story.

The processor may be further configured to perform the conversion of each respective story into the respective embedding and the conversion of the new story into the new embedding by using an E5 embedding model.

The processor may be further configured to perform the comparison and the generation of the respective similarity score by using a first artificial intelligence/machine learning (AI/ML) model that is trained by using historical testing artefact data.

The processor may be further configured to perform the comparison by applying a predetermined cosine similarity algorithm to each respective embedding with respect to the new embedding.

The identification of the at least one respective testing artefact that is associated with the respective story may include an identification of at least a predetermined number of respective testing artefacts. The predetermined number of respective testing artefacts may be greater than or equal to five (5).

According to yet another embodiment, a non-transitory computer readable storage medium storing instructions for identifying and recommending software artefacts for reuse for testing new software functionality is provided. The storage medium includes a set of executable code which, when executed by a processor, causes the processor to: receive a first set of stories, each respective story included in the first set of stories including a natural language textual description of a respective set of user requirements; convert, by using a predetermined text vectorization technique, each respective story into a respective embedding that includes a respective vector representation of the respective story; store each respective embedding in a vector database; receive, from a first user, a new story that includes a natural language textual description of a first set of requirements that correspond to the first user; convert, by using the predetermined text vectorization technique, the new story into a new embedding; compare the new embedding to each respective embedding stored in the vector database; generate, based on a result of the comparing for each respective embedding, a respective similarity score that relates to a respective semantic similarity between the respective embedding and the new embedding; rank-order each respective embedding based on the respective similarity score; for a respective embedding having at least a predetermined first rank, identify at least one respective testing artefact that is associated with the respective story; generate a list of recommendations based on the identified at least one testing artefact; and display the list via a display that is accessible by the first user.

The at least one respective testing artefact may include at least one from among a manual test plan that is associated with the respective story and an automated test script that is associated with the respective story.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using a semantic search approach for identifying and recommending testing software artefacts for reuse for testing new software functionality, in accordance with an embodiment.

FIG. 2 illustrates an exemplary diagram of a network environment with a device for using a semantic search approach for identifying and recommending testing software artefacts for reuse for testing new software functionality, in accordance with an embodiment.

FIG. 3 illustrates a system diagram for implementing a method for using a semantic search approach for identifying and recommending testing software artefacts for reuse for testing new software functionality, in accordance with an embodiment.

FIG. 4 illustrates an exemplary flow chart of a process for using a semantic search approach for identifying and recommending testing software artefacts for reuse for testing new software functionality, in accordance with an embodiment.

FIG. 5 illustrates a data flow and logical framework of a system for using a semantic search approach for identifying and recommending testing software artefacts for reuse for testing new software functionality, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for identification and recommendation of suitable software artefacts for reuse may reduce unnecessary usage of system resources, such as memory capacity and system throughput, which may otherwise be required by the software development and testing process. In addition, the identification and recommendation of suitable software artefacts for reuse may also improve computer functionality by advantageously leveraging the fact that the reusable code has previously been tested and successfully deployed. In particular, the system or method may achieve these improvements by: receiving a first set of stories, each respective story included in the first set of stories including a natural language textual description of a respective set of user requirements; converting, by using a predetermined text vectorization technique, each respective story into a respective embedding that includes a respective vector representation of the respective story; storing each respective embedding in a vector database; receiving, from a first user, a new story that includes a natural language textual description of a first set of requirements that correspond to the first user; converting, by using the predetermined text vectorization technique, the new story into a new embedding; comparing the new embedding to each respective embedding stored in the vector database; generating, based on a result of the comparing for each respective embedding, a respective similarity score that relates to a respective semantic similarity between the respective embedding and the new embedding; rank-ordering each respective embedding based on the respective similarity score; for a respective embedding having at least a predetermined first rank, identifying at least one respective testing artefact that is associated with the respective story; generating a list of recommendations based on the identified at least one testing artefact; and displaying the list via a display that is accessible by the first user.

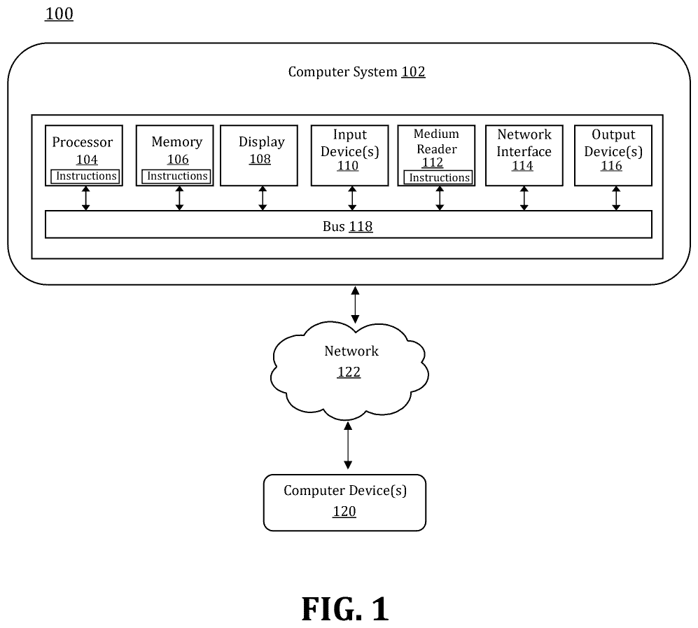

FIG. 1 is an exemplary system 100 for use in implementing a method for using a semantic search approach for identifying and recommending testing software artefacts for reuse for testing new software functionality, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

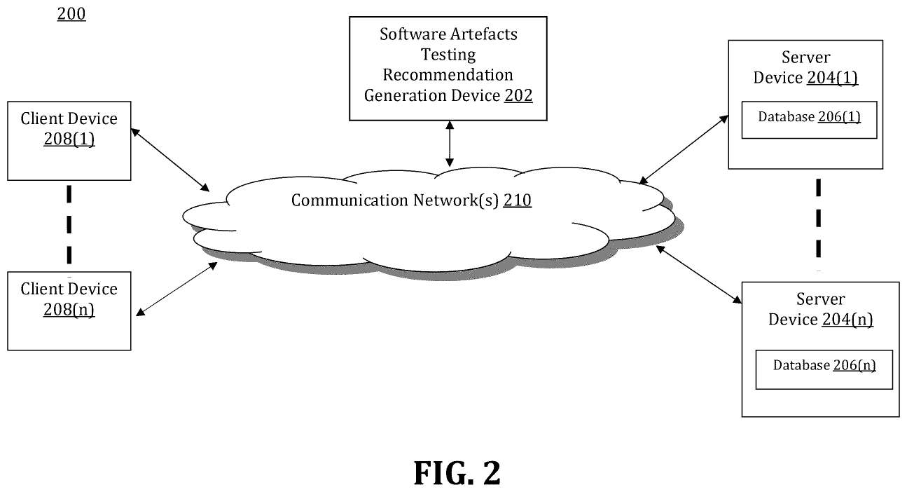

Referring to FIG. 2, a schematic of an exemplary network environment 200 for implementing a software artefacts testing recommendation generation device (SATRGD) of the instant disclosure is illustrated.

In some embodiments, the above-described problems associated with conventional tools may be overcome by implementing an SATRGD 202 as illustrated in FIG. 2 that may be configured for implementing a method for using a semantic search approach for identifying and recommending testing software artefacts for reuse for testing new software functionality, but the disclosure is not limited thereto.

The SATRGD 202 may have one or more computer system 102s, as described with respect to FIG. 1, which in aggregate provide the necessary functions.

The SATRGD 202 may store one or more applications that can include executable instructions that, when executed by the SATRGD 202, cause the SATRGD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SATRGD 202 itself, may be located in virtual server(s) running in a cloud-based computing environment rather than being tied to one or more specific physical network computing devices. Also, the application(s) may be running in one or more virtual machines (VMs) executing on the SATRGD 202. Additionally, in one or more embodiments of this technology, virtual machine(s) running on the SATRGD 202 may be managed or supervised by a hypervisor.

In the network environment 200 of FIG. 2, the SATRGD 202 is coupled to a plurality of server devices 204(1)-204(n) that hosts a plurality of databases 206(1)-206(n), and also to a plurality of client devices 208(1)-208(n) via communication network(s) 210. A communication interface of the SATRGD 202, such as the network interface 114 of the computer system 102 of FIG. 1, operatively couples and communicates between the SATRGD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SATRGD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SATRGD 202 may be a standalone device or integrated with one or more other devices or apparatuses, such as one or more of the server devices 204(1)-204(n), for example. In one particular example, the SATRGD 202 may be hosted by one of the server devices 204(1)-204(n), and other arrangements are also possible. Moreover, one or more of the devices of the SATRGD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SATRGD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the SATRGD 202 that may efficiently provide a platform for implementing a method for using a semantic search approach for identifying and recommending testing software artefacts for reuse for testing new software functionality, but the disclosure is not limited thereto.

The client devices 208(1)-208(n) may run interface applications, such as standard web browsers or standalone client applications, which may provide an interface to communicate with the SATRGD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SATRGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SATRGD 202, the server devices 204(1)-204(n), or the client devices 208(1)-208(n), for example, may be configured to operate as virtual instances on the same physical machine. For example, one or more of the SATRGD 202, the server devices 204(1)-204(n), or the client devices 208(1)-208(n) may operate on the same physical device rather than as separate devices communicating through communication network(s) 210. Additionally, there may be more or fewer SATRGDs 202, server devices 204(1)-204(n), or client devices 208(1)-208(n) than illustrated in FIG. 2. In some embodiments, the SATRGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

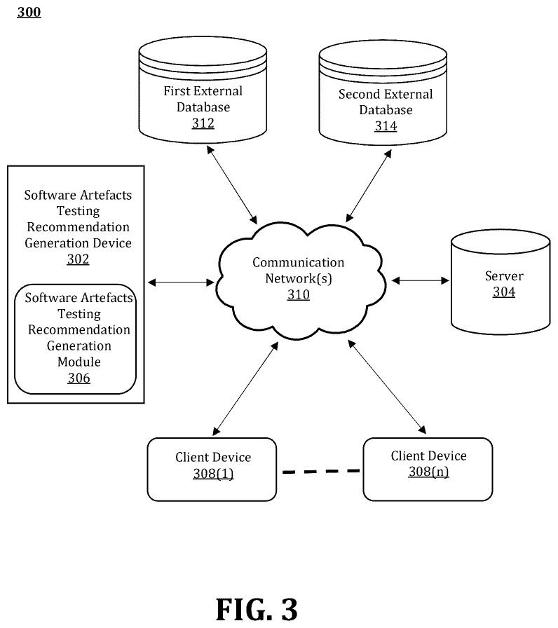

FIG. 3 illustrates a system diagram for implementing an SATRGD 302 having a software artefact testing recommendation generation module (SATRGM), in accordance with an embodiment.

As illustrated in FIG. 3, the system 300 may include an SATRGD 302 within which an SATRGM 306 is embedded, a server 304, a first external database 312, a second external database 314, a plurality of client devices 308(1) . . . 308(n), and a communication network 310.

In some embodiments, the SATRGD 302 including the SATRGM 306 may be connected to the server 304, and the database(s) 312 via the communication network 310. The SATRGD 302 may also be connected to the plurality of client devices 308(1) . . . 308(n) via the communication network 310, but the disclosure is not limited thereto.

In an embodiment, the SATRGD 302 is described and shown in FIG. 3 as including the SATRGM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the SATRGM 306 may be configured to receive real-time feed of data from the plurality of client devices 308(1) . . . 308(n) and secondary sources via the communication network 310.

As may be described below, the SATRGM 306 may be configured to: receive a first set of stories, each respective story included in the first set of stories including a natural language textual description of a respective set of user requirements; convert, by using a predetermined text vectorization technique, each respective story into a respective embedding that includes a respective vector representation of the respective story; store each respective embedding in a vector database; receive, from a first user, a new story that includes a natural language textual description of a first set of requirements that correspond to the first user; convert, by using the predetermined text vectorization technique, the new story into a new embedding; compare the new embedding to each respective embedding stored in the vector database; generate, based on a result of the comparing for each respective embedding, a respective similarity score that relates to a respective semantic similarity between the respective embedding and the new embedding; rank-order each respective embedding based on the respective similarity score; for a respective embedding having at least a predetermined first rank, identify at least one respective testing artefact that is associated with the respective story; generate a list of recommendations based on the identified at least one testing artefact; and display the list via a display that is accessible by the first user, but the disclosure is not limited thereto.

The plurality of client devices 308(1) . . . 308(n) are illustrated as being in communication with the SATRGD 302. In this regard, the plurality of client devices 308(1) . . . 308(n) may be “clients” (e.g., customers) of the SATRGD 302 and are described herein as such. Nevertheless, it is to be known and understood that the plurality of client devices 308(1) . . . 308(n) need not necessarily be “clients” of the SATRGD 302, or any entity described in association therewith herein. Any additional or alternative relationship may exist between either or both of the plurality of client devices 308(1) . . . 308(n) and the SATRGD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the SATRGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SATRGD 302 may be the same or similar to the SATRGD 202 as described with respect to FIG. 2, including any features or combination of features described with respect thereto.

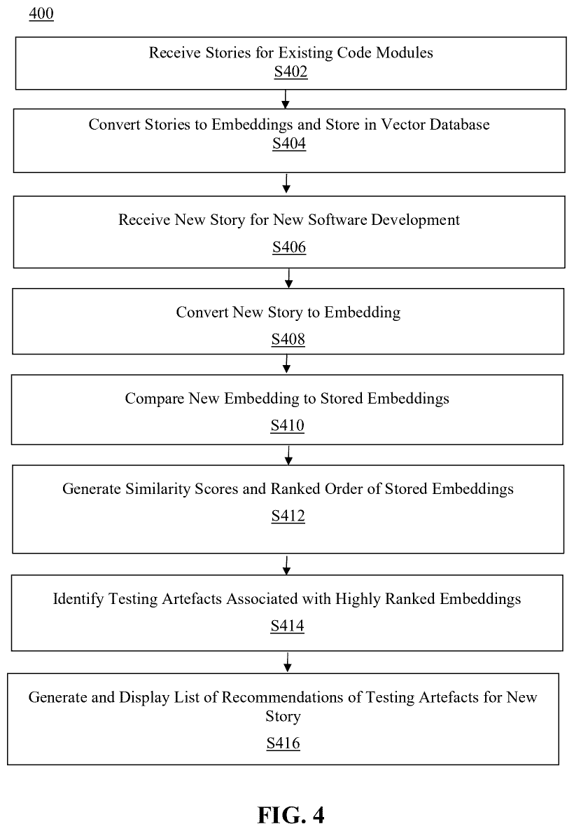

FIG. 4 illustrates an exemplary flow chart of a process 400 implemented by the SATRGM 306 of FIG. 3 for enablement of a system and a method for using a semantic search approach for identifying and recommending testing software artefacts for reuse for testing new software functionality, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving a first set of stories that correspond to existing software code modules, each story including a natural language textual description of a respective set of user requirements. Then, at step S404, the process may include converting each story included in the first set of stories into a respective embedding. In an embodiment, the conversion of each story into a respective embedding is performed by using a predetermined text vectorization technique, such as, for example, using an E5 vectorization model; and the result of each conversion is a respective vector representation of the corresponding story. In an embodiment, each respective embedding is stored in a vector database.

In an embodiment, each conversion may be performed by using at least one data ablation study to determine which portions of the corresponding story have significant relevance, and then generating the respective embedding based on the portions that have been determined as having significant relevance. In an embodiment, each respective story always includes at least a summary and a description, and the summary and the description are always determined as having significant relevance.

At step S406, the process 400 may include receiving, from a first user, a new story that corresponds to a new software development. In an embodiment, the new story includes a natural language textual description of a set of user requirements that correspond to the first user for the new software development. Then, at step S408, the process may include converting the new story into a new embedding by using the same predetermined text vectorization technique as that used in step S404.

At step S410, the process 400 may include comparing the new embedding to each respective embedding stored in the vector database as a result of the conversions performed in step S404. In an embodiment, the comparing operations may be performed by using a first artificial intelligence/machine learning (AI/ML) model that is trained by using historical software testing artefact data. In an embodiment, each comparison may be performed by applying a predetermined cosine similarity algorithm to each respective embedding with respect to the new embedding.

At step S412, the process 400 may include using the result of each comparison performed in step S410 to generate a respective similarity score that relates to a respective semantic similarity between the respective embedding and the new embedding. In an embodiment, the similarity scores may fall within a predetermined range, such as a range of between negative one (i.e., −1.0) and positive one (i.e., +1.0), that corresponds to the predetermined cosine similarity algorithm. In an embodiment, after all of the comparisons have been performed and all of the similarity scores have been generated, an ordered list of the respective embeddings may be generated by rank-ordering each respective embedding based on the respective similarity score. In an embodiment, the generation of each similarity score may be performed by using an AI/ML model, such as, for example, the same AI/ML model that may be used for performing the comparisons in step S410.

At step S414, the process 400 may include identifying software testing artefacts that are associated with each respective story that corresponds to a respective embedding that has a relatively high ranking in the ordered list of the respective embeddings generated in step S412. In an embodiment, the software testing artefacts may include manual test plans and/or automated test scripts that are associated with a particular story included in the first set of stories received in step S402. In an embodiment, any particular story may be associated with more than one software testing artefact.

In an embodiment, a predetermined rank may be selected as corresponding to a minimum rank for a purpose of identifying corresponding software testing artefacts, and then each embedding having at least the selected minimum rank may be used for this purpose, where a ranking of one (1) is deemed as being the highest possible rank, and a rank having a higher numerical value corresponds to a commensurately lower rank. For example, if the list includes a rank ordering of 25 embeddings, then a minimum rank of 3 may be selected, and then the embeddings having ranks 1, 2, and 3 may be used for identifying corresponding software testing artefacts in step S414. In an embodiment, a minimum number of software testing artefacts may also be selected, and if the number of identified software testing artefacts is lower than the selected minimum, then the minimum rank may be adjusted to allow for additional testing artefacts to be identified. For example, the minimum number of testing artefacts may be selected as being equal to five (5), and if the minimum rank of 3 yields less than 5 identifications of software testing artefacts, then the minimum rank may be adjusted to a different value, such as 5 or 8 or 10 or any suitable minimum rank value.

At step S416, the process 400 may include generating a list of recommendations of software testing artefacts for the new story, and displaying the list of recommendations via a display that is accessible by the first user. In an embodiment, the displaying the list of recommendations may include displaying, for each respective identified testing artefact, a respective set of buttons that are configured to facilitate interaction with the first user. For example, the respective set of buttons may include a first button that corresponds to downloading the respective identified testing artefact, a second button that corresponds to providing first feedback that indicates that the respective identified testing artefact is fully useful, a third button that corresponds to providing second feedback that indicates that the respective identified testing artefact is partly useful, and a fourth button that corresponds to providing third feedback that indicates that the respective identified testing artefact is not useful.

The reuse of software artefacts is a powerful tool that has the power to reduce the effort spent and time taken to develop software while improving the output by reusing mature, well-tested code. Testing is one area of software development that can benefit greatly from reuse as many software tests are very similar to each other and it often holds that similar functionality is tested by similar tests. In an embodiment, a tool that finds and recommends existing testing artefacts to reuse for testing new functionality is provided, and may be referred to herein as a Software Testing Artefact Recommendation using Semantic Search (STARS) tool. In an embodiment, the STARS tool represents a general approach that can be implemented to be integrated with any software lifecycle tool, such as Issue Tracking Systems (ITS) or Integrated Development Environments (IDE), where it can be specifically effective. In an embodiment, STARS may be applied to Jira, i.e., a popular ITS, and STARS may thusly be hosted as a web application.

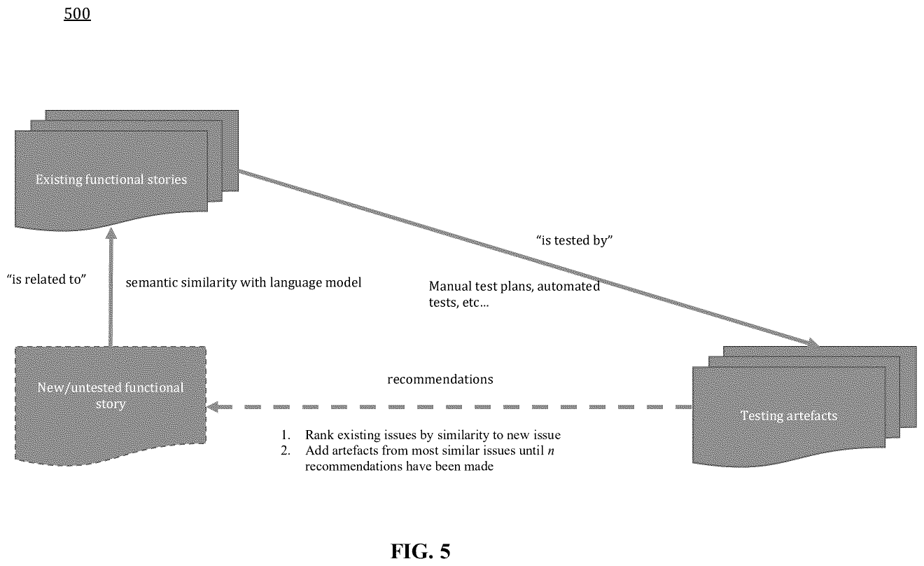

FIG. 5 illustrates a data flow and logical framework 500 of a system for using a semantic search approach for identifying and recommending testing software artefacts for reuse for testing new software functionality, in accordance with an embodiment. As illustrated in FIG. 5, the STARS approach is facilitated by exploiting the links between functional stories, i.e., short descriptions of the corresponding user requirements, written in natural language and stored in an issue tracking system, together with links from those stories to their associated testing artefacts. In an embodiment, these links may be exploited to make recommendations for a new functionality by first using semantic search to find similar stories to the new story and then using the testing artefacts that are linked to each such similar story to build a ranked recommendation list which is provided to the developer for review.

Stage 1—Discovering Similar Stories: Referring again to FIG. 5, in an embodiment, in order to make recommendations, the STARS tool first establishes and maintains a data store of existing functional stories against which searches may be performed. As also illustrated in steps S402, S404, and S406 of FIG. 4, this may be done by using a vector database that stores embeddings for each story. As also illustrated in steps S408, S410, and S412 of FIG. 4, when there is a need to make a recommendation for a new story, the new story may be used as a query, and a semantic search may be performed over the other stories based on the query story in order to generate a list of stories that are ranked by their respective similarity to the query story. In an embodiment, the embeddings may be computed over the most relevant parts of the stories, such as the summary and description, and this data store is kept up to date through regular periodic runs of the story ingestion pipeline. In an embodiment, the E5 embedding model may be used to generate semantically meaningful embeddings for stories, but the disclosure is not limited thereto, as any text vectorization or embedding method may be used. In an embodiment, the determining of the most relevant parts of the story may be performed by using AI/ML techniques, such as data ablation studies. To perform a search against the embeddings, any pairwise vector comparison may be used. In an embodiment, advantageous use may be made of a cosine similarity algorithm, which is a high performing algorithm to compare long numerical vectors.

Stage 2—Building a Recommendation List: Referring again to FIG. 5, once a ranked list of similar stories has been generated, the ranked list of similar stories may then be used to build a list of testing artefact recommendations. In an embodiment, as also illustrated in step S414 of FIG. 4, the first step in this stage is to discover the testing artefacts associated with the similar stories. A specific mechanism by which how these links may be discovered is dependent on the system under test and how the data is organized. In an embodiment, there are two types of testing artefacts, i.e., manual test plans and automated test scripts.

In an embodiment, based on the ability to discover testing artefacts linked to stories, the recommendation list may be generated by applying the following algorithm: 1) Rank stories by relation/similarity to query story; and 2) for each similar story in ranked order, first add testing artefacts that are linked to the query story to the list of recommendations, and then continue adding testing artefacts until at least a predetermined number N of recommendations have been made. In an embodiment, this algorithm produces a ranked recommendation list that is ordered by a likely suitability of the recommendation.

In an embodiment, the ordering of the recommendation list follows the logic that the more similar a particular story is to the query story, the more likely it is that the testing artefacts associated with that particular story will be a good match for testing the query story. As the rank of a recommendation corresponds to the similarity rank of the story from which the recommendation is generated, it is possible to have multiple recommendations of the same rank where a single story has multiple testing artefacts.

Stage 3—Presenting the Recommendations: Referring again to FIG. 5, in an embodiment, the STARS tool can be implemented as an add-on or a stand-alone graphical interface. For example, the STARS tool may be implemented as a stand-alone web application. In an embodiment, a user interface (UI) may accept, as input, a project name and a project identifier (ID) of a new story as a prompt to generate recommendations of software testing artefacts, and in response to this prompt, the STARS tool may generate and present a list of ranked recommendations as a list of expandable panels. In an embodiment, the contents of each particular recommendation may be displayed in an expanded panel, and options may be provided to download the particular recommendation and to provide feedback to help improve and evaluate the tool. In an embodiment, this feedback may be split into three categories: 1) “Fully Useful” for when the recommendation is enough to fully satisfy the testing requirements; 2) “Partially Useful” for when the recommendation only partially satisfies the testing requirements; and 3) “Not Useful” for when the recommendation is not useful or relevant.

In an embodiment, the STARS tool may be integrated into an AI-powered software engineering toolkit, and may be configured to take advantage of regular data ingest and gathering of feedback. Such feedback may then be used to assess and improve performance, including refinement of the semantic search AI component and embedding model. In addition, new test plans and automated test scripts may be generated based on the new story and historical information, in order to augment the repository of existing software testing artefacts.

In some embodiments as disclosed above in FIGS. 1-5, technical improvements effected by the instant disclosure may include a platform for implementing a software artefacts testing recommendation generation module configured for enablement of using a semantic search approach for identifying and recommending testing software artefacts for reuse for testing new software functionality, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying and recommending software artefacts for reuse for testing new software functionality, the method being implemented by at least one processor, the method comprising:
receiving a first set of stories, each respective story included in the first set of stories including a natural language textual description of a respective set of user requirements;
converting, by using a predetermined text vectorization technique, each respective story into a respective embedding that includes a respective vector representation of the respective story;
storing each respective embedding in a vector database;
receiving, from a first user, a new story that includes a natural language textual description of a first set of requirements that correspond to the first user;
converting, by using the predetermined text vectorization technique, the new story into a new embedding;
comparing the new embedding to each respective embedding stored in the vector database;
generating, based on a result of the comparing for each respective embedding, a respective similarity score that relates to a respective semantic similarity between the respective embedding and the new embedding;
rank-ordering each respective embedding based on the respective similarity score;
for a respective embedding having at least a predetermined first rank, identifying at least one respective testing artefact that is associated with the respective story;
generating a list of recommendations based on the identified at least one testing artefact; and
displaying the list via a display that is accessible by the first user.

2. The method of claim 1, wherein the at least one respective testing artefact includes at least one from among a manual test plan that is associated with the respective story and an automated test script that is associated with the respective story.

3. The method of claim 1, further comprising displaying, for each respective identified testing artefact, a respective set of buttons that are configured to facilitate interaction with the first user, the respective set of buttons including a first button that corresponds to downloading the respective identified testing artefact, a second button that corresponds to providing first feedback that indicates that the respective identified testing artefact is fully useful, a third button that corresponds to providing second feedback that indicates that the respective identified testing artefact is partly useful, and a fourth button that corresponds to providing third feedback that indicates that the respective identified testing artefact is not useful.

4. The method of claim 1, wherein the converting of each respective story into the respective embedding comprises:
using at least one data ablation study to determine at least one portion of the respective story that has significant relevance; and
generating the respective embedding based on the at least one portion of the respective story that is determined as having the significant relevance.

5. The method of claim 4, wherein the at least one portion of the respective story that is determined as having the significant relevance includes each of a summary of the respective story and a description of the respective story.

6. The method of claim 1, wherein the converting of each respective story into the respective embedding and the converting of the new story into the new embedding are performed by using an E5 embedding model.

7. The method of claim 1, wherein the comparing and the generating of the respective similarity score are performed by using a first artificial intelligence/machine learning (AI/ML) model that is trained by using historical testing artefact data.

8. The method of claim 7, wherein the comparing comprises applying a predetermined cosine similarity algorithm to each respective embedding with respect to the new embedding.

9. The method of claim 1, wherein the identifying of the at least one respective testing artefact that is associated with the respective story comprises identifying at least a predetermined number of respective testing artefacts, and wherein the predetermined number of respective testing artefacts is greater than or equal to five (5).

10. A computing apparatus for identifying and recommending software artefacts for reuse for testing new software functionality, the computing apparatus comprising:
a processor;
a memory; and
a communication interface coupled to each of the processor and the memory,
wherein the processor is configured to:
receive, via the communication interface, a first set of stories, each respective story included in the first set of stories including a natural language textual description of a respective set of user requirements;
convert, by using a predetermined text vectorization technique, each respective story into a respective embedding that includes a respective vector representation of the respective story;
store each respective embedding in a vector database within the memory;
receive, from a first user via the communication interface, a new story that includes a natural language textual description of a first set of requirements that correspond to the first user;
convert, by using the predetermined text vectorization technique, the new story into a new embedding;
compare the new embedding to each respective embedding stored in the vector database;
generate, based on a result of the comparison for each respective embedding, a respective similarity score that relates to a respective semantic similarity between the respective embedding and the new embedding;
rank-order each respective embedding based on the respective similarity score;
for a respective embedding having at least a predetermined first rank, identify at least one respective testing artefact that is associated with the respective story;
generate a list of recommendations based on the identified at least one testing artefact; and
display the list via a display that is accessible by the first user.

11. The computing apparatus of claim 10, wherein the at least one respective testing artefact includes at least one from among a manual test plan that is associated with the respective story and an automated test script that is associated with the respective story.

12. The computing apparatus of claim 10, wherein the processor is further configured to display, for each respective identified testing artefact, a respective set of buttons that are configured to facilitate interaction with the first user, the respective set of buttons including a first button that corresponds to downloading the respective identified testing artefact, a second button that corresponds to providing first feedback that indicates that the respective identified testing artefact is fully useful, a third button that corresponds to providing second feedback that indicates that the respective identified testing artefact is partly useful, and a fourth button that corresponds to providing third feedback that indicates that the respective identified testing artefact is not useful.

13. The computing apparatus of claim 10, wherein the processor is further configured to perform the conversion of each respective story into the respective embedding by:
using at least one data ablation study to determine at least one portion of the respective story that has significant relevance; and
generating the respective embedding based on the at least one portion of the respective story that is determined as having the significant relevance.

14. The computing apparatus of claim 13, wherein the at least one portion of the respective story that is determined as having the significant relevance includes each of a summary of the respective story and a description of the respective story.

15. The computing apparatus of claim 10, wherein the processor is further configured to perform the conversion of each respective story into the respective embedding and the conversion of the new story into the new embedding by using an E5 embedding model.

16. The computing apparatus of claim 10, wherein the processor is further configured to perform the comparison and the generation of the respective similarity score by using a first artificial intelligence/machine learning (AI/ML) model that is trained by using historical testing artefact data.

17. The computing apparatus of claim 16, wherein the processor is further configured to perform the comparison by applying a predetermined cosine similarity algorithm to each respective embedding with respect to the new embedding.

18. The computing apparatus of claim 10, wherein the identification of the at least one respective testing artefact that is associated with the respective story comprises an identification of at least a predetermined number of respective testing artefacts, and wherein the predetermined number of respective testing artefacts is greater than or equal to five (5).

19. A non-transitory computer readable storage medium storing instructions for identifying and recommending software artefacts for reuse for testing new software functionality, the storage medium comprising executable code which, when executed by a processor, causes the processor to:
receive a first set of stories, each respective story included in the first set of stories including a natural language textual description of a respective set of user requirements;
convert, by using a predetermined text vectorization technique, each respective story into a respective embedding that includes a respective vector representation of the respective story;
store each respective embedding in a vector database;
receive, from a first user, a new story that includes a natural language textual description of a first set of requirements that correspond to the first user;
convert, by using the predetermined text vectorization technique, the new story into a new embedding;
compare the new embedding to each respective embedding stored in the vector database;
generate, based on a result of the comparing for each respective embedding, a respective similarity score that relates to a respective semantic similarity between the respective embedding and the new embedding;
rank-order each respective embedding based on the respective similarity score;
for a respective embedding having at least a predetermined first rank, identify at least one respective testing artefact that is associated with the respective story;
generate a list of recommendations based on the identified at least one testing artefact; and
display the list via a display that is accessible by the first user.

20. The storage medium of claim 19, wherein the at least one respective testing artefact includes at least one from among a manual test plan that is associated with the respective story and an automated test script that is associated with the respective story.
